(19) United States
(12) Patent Application Publication
(10) Pub. No.: US 2021/0356745 A1
(43) Pub. Date: Nov. 18, 2021

(54) METHOD FOR PRODUCING A HOLOGRAPHIC OPTICAL ELEMENT (HOE), WHICH IS PROVIDED FOR PROJECTION IN A PROJECTION SYSTEM, A HOLOGRAPHIC OPTICAL ELEMENT OF THIS KIND, PROJECTION DEVICE, LENS FOR DATA GLASSES AND DATA GLASSES OF THIS KIND

(71) Applicant: Robert Bosch GmbH, Stuttgart (DE)

(72) Inventor: Tobias GRAF, Überlingen (DE)

(21) Appl. No.: 17/280,579

(22) PCT Filed: Dec. 6, 2019
(86) PCT No.: PCT/EP2019/083924

§ 371 Date: Mar. 26, 2021

(30) Foreign Application Priority Data
Dec. 12, 2018 (DE) 10 2018 221 565.0

(51) Int. Cl. G02B 27/01; G03H 1/04; G02B 5/32

(52) U.S. Cl. CPC G02B 27/0172; G03H 1/0402; G02B 5/32; G03H 2270/55; G02B 2027/0174; G02B 2027/0178; G03H 2001/0415; G03H 2001/0439

(57) ABSTRACT

A method for producing a holographic optical element (HOE) that is provided for projection in a projection system. A hologram is recorded by the fact that a first Gaussian beam and a second Gaussian beam are caused to interfere on a holographic film for at least two different configurations. The first Gaussian beam is a reference beam that, for the at least two different configurations, is identical to a reconstruction beam with which the HOE is reconstructed. The second Gaussian beam is furthermore an object beam that, upon reconstruction of the HOE utilizing the reconstruction beam, is identical to a projection beam that is used in the projection system for projection. For the at least two different configurations, at least one beam property that depends respectively on predefined projection properties of the projection system is predefined for the second Gaussian beam.

### FIELD

The present invention relates to a method for producing a holographic optical element (HOE) that is provided for projection in a projection system, to a holographic optical element of this kind, to a projection apparatus, to an eyeglass lens for data glasses, and to data glasses of this kind.

### BACKGROUND INFORMATION

German Patent Application No. DE 2016 201 567 A1 describes a projection apparatus for data glasses. The projection apparatus encompasses an image generation unit for generating at least a first light beam representing a first image datum and a second light beam representing a second image datum. The first light beam and the second light beam differ from one another in terms of a beam divergence. The first image datum and the second image datum furthermore differ from one another in terms of a perceptible image sharpness. The projection apparatus further encompasses at least one deflection element that is embodied to display the first image datum, using the first light beam, within a first field of view of an eye, and to display the second image datum, using the second light beam, within a second field of view, located outside the first field of view, of the eye.

### SUMMARY

In spherical wave deflectors, which are conventional analog holograms, a holographic layer can be illuminated using, for example, a divergent and a convergent spherical wave upon recording, so that upon playback using one of the two spherical waves, the light is diffracted at the holographic layer in such a way that it becomes deflected into a second convergent spherical wave. This method allows the deflection of light in configurations that are not subject to the law of reflection.

If an HOE of this kind is illuminated locally with a Gaussian beam proceeding, for instance, from the position of the point source, it is deflected toward the target point onto which the convergent spherical wave that was used to record the spherical wave deflector would converge.

Conventional near-eye displays may be based on holographic deflection elements.

Other near-eye displays that are based on holographic deflection elements are known as retinal scanner displays (RSDs), and use (at least) one MEMS mirror to scan a beam over the holographic deflection element which in turn deflects it to the user's pupil, so that by controlled activation of the light source and mirror, light stimulation can be placed directly onto the retina.

The development of helmet-mounted or head-mounted displays (HMDs) or head-worn displays (HWDs) has been an active area of research since the 1960s. Virtual reality (VR) systems are one manifestation. It is principally the development of augmented-reality (AR) or mixed-reality devices, however, that creates interesting possibilities for situation-related and individualized information provision for work-related and everyday use.

Because of their high cost and bulky optics, HMDs have hitherto been used principally in the military sector. Civilian professionals and consumers can also benefit, however, from a compact and inexpensive HMD device for everyday and leisure-time use. Until now, however, it has not been possible to successfully market a consumer product produced in large volumes. One major challenge in this context is, for example, the interacting influence of requirements in terms of optical and mechanical specifications. Two different types of HMDs are commercially available at present. On the one hand there are lightweight, manageable HMDs whose image-producing and sensory system is kept as small as possible, and for that reason they also have only a limited range of functions. On the other hand there are HMDs with relatively bulky optics, optionally in combination with several sensors and cameras, which make possible more-demanding image presentations and interactions between environmental perception and overlaid image information but are considerably larger, heavier, and less ergonomic in terms of handling.

One approach to achieving high-quality imaging along with a maximally space-saving configuration involves a laser-based retinal scanner. In contrast to most other concepts, this does not use an imaging optic that superimposes an image of a display surface via an imaging system into the user's field of view. Instead, a beam is generated here using at least one laser source (with polychromatic systems also using several), and that beam can be deflected via a microelectromechanical system (MEMS) mirror and scanned over the retina by deflection of the mirror.

Because of the latency time in the human visual system, by controlled activation of the mirror and laser source it is thus possible to generate the impression of a planar image or of superimposed image contents. The advantage of this system concept is the small number of optical components, which moreover require little installation space.

The free-space propagation of a Gaussian beam is determined principally by the wavelength and by the radius of the beam waist. The propagation of a Gaussian beam through a refractive lens is described principally by way of the wavelength and beam waist of the input beam and by the focal length of the lens and the location of the beam waist with respect to the lens, analogously to the object-side intercept distance in imaging optics.

Upon illumination of a conventional, analog holographic deflection element, for example a spherical wave deflector, with a Gaussian beam, the latter is deflected, given a corresponding angle of incidence, at an angle of reflection; in this case the angle of reflection is not equal to the angle of incidence. Diffraction at the holographic layer results, however, in the overlaying of additional phase terms that can result in a deviation of the propagation behavior from free-space propagation over a comparable distance.

The result of this is that important beam parameters, for example the radius and location of the beam waist, are influenced by the HOE in addition to free-space propagation, which can result in considerable deviations from the expected system properties. In particular, a beam profile of a Gaussian beam deflected by a spherical wave deflection as a rule is not symmetrical.

The present method in accordance with an example embodiment of the present invention serves to produce a holographic optical element that is provided for projection in a projection system. A projection system, or projector, can be an optical device with which a two-dimensional original (e.g., an image) is imaged onto a projection surface or image surface. The projection system can also be a retinal scanner.

In accordance with the method of an example embodiment of the present invention, a hologram is recorded by the fact that a first Gaussian beam and a second Gaussian beam are caused to interfere on a holographic film for at least two different configurations.

For each configuration, the interference is exposed on the holographic film until a sub-hologram is recorded. As a rule, the laser or lasers that generate the first and the second Gaussian beam are switched off in the context of the method between the different configurations. Alternatively or additionally, the laser or lasers can be blocked by way of a movable stop and/or can be temporarily diverted into a beam trap via a movable mirror.

Each configuration of the at least two different configurations of the first or second Gaussian beam is characterized by at least one beam property.

In accordance with a preferred embodiment of the present invention, the at least one beam property is selected from a list that encompasses a propagation direction, a size of a beam waist, or a position of the beam waist. A size of the beam waist for a Gaussian beam can be different along orthogonal spatial directions that are perpendicular to the propagation direction.

One beam waist can therefore exist for an X axis, and one beam waist for a Y axis. A position of these two beam waists along the propagation direction can be different. An ellipticity or a beam radius on the HOE can also be part of the aforementioned list.

A “Gaussian beam” is understood here as the TEM00 fundamental spatial mode. The intensity profile along a first spatial direction perpendicular to the propagation direction is a Gaussian distribution. This first spatial direction can be called an “X axis.” The distribution along the propagation direction, which is called a “Z axis,” exhibits a beam waist at a specific point XO. The Gaussian beam also exhibits a Gauss-shaped intensity distribution along a second spatial direction that is perpendicular to the first spatial direction and is called a “Y axis.” The point along the Z axis at which this distribution has a minimum extent does not, however, need to coincide with point XO, but can instead be a different point (called “Y0”). In general, the intensity distribution of a Gaussian beam of this kind is elliptical in the XY plane.

Each configuration can be characterized by different beam parameters. Each configuration can have, for example, identical or similar beam parameters for a subset of the beam parameters, and different beam parameters for the complementary subset of the beam parameters. One example of this is, for instance, that the propagation direction is different for each configuration but the beam parameters are otherwise identical, or identical within a predefined range; for instance, the beam can be rotationally symmetrical for each configuration, and a spacing of the beam waist from the HOE can be the same for each configuration. A further example can be that the second Gaussian beam exhibits a similar ellipticity for all configurations, for instance for all angular positions of the reflection element, i.e., that the ellipticity lies within a predefined range for all angular positions.

The first Gaussian beam is a reference beam that, for at least two different configurations, is identical to a reconstruction beam or a reference beam with which the HOE is reconstructed. The reconstruction beam can have different beam properties for different configurations. The reconstruction beam for the different configurations can thus be generated with the aid of different lasers each having different optics.

The first Gaussian beam is preferably directed onto the holographic film with the aid of a scanning unit that is usable in a retinal scanner. The first Gaussian beam is preferably generated with the aid of a laser beam source, the generated laser beam being directed onto the holographic film with the aid of a reflection element. The reflection element can alternatively be referred to as a “scanning mirror” or “microelectromechanical system (MEMS) mirror.”

It is further preferred, in accordance with an example embodiment of the present invention, that no optical element be disposed between the reflection element and the HOE. An “optical element” is an apparatus that modifies beam properties differently from propagation of the light beam through air. It is further preferred that the generated hologram or HOE be used in a set of data glasses having the same scanning unit.

Furthermore, the second Gaussian beam is an object beam that, in the context of reconstruction of the HOE utilizing the reconstruction beam, is identical to a projection beam that is used in the projection system for projection.

In accordance with an example embodiment of the present invention, in the method, at least one beam property that depends respectively on predefined projection properties of the projection system is predefined for the projection beam for the at least two different configurations.

An advantageous result of the method is that an HOE produced using the method generates, by local illumination with a Gaussian beam having predetermined, precisely defined beam properties, a Gaussian beam that can be adapted particularly exactly to the requirements of a projection system.

In accordance with a preferred embodiment of the method of the present invention, the HOE is produced by the fact that the first Gaussian beam illuminates the holographic film at a first predefined angle and the second Gaussian beam illuminates it at a second predefined angle, in such a way that the first Gaussian beam and the second Gaussian beam each illuminate the holographic film locally, i.e., at a positionally delimited location.

Because of the property that a Gaussian beam incident onto the HOE becomes deflected into another Gaussian beam, an HOE that is produced using the method is also referred to as a “holographic Gaussian beam deflector.”

In accordance with a further preferred embodiment of the present invention, a quality function for the second Gaussian beam is optimized. The advantageous result thereof is that predefined properties of the second Gaussian beam can be optimized, in particular can be adapted to the projection system.

In accordance with yet another further preferred embodiment of the present invention, the quality function is a weighted summing function that has, for the at least two different configurations and for a respective predefined location between the HOE and a projection surface, a respective summand that is a variable derived from the at least one beam property. The variable derived from the at least one beam property can be, for example, a spot variable, a symmetry of the Gaussian beam, an ellipticity of the spot, or other variables derived from the at least one beam property. A further derived property can be a mathematical function of a derived variable, for instance the absolute-value square or absolute square of the ellipticity of the spot. The aforementioned quality function advantageously results in suitable characterization of the second Gaussian beam for all different configurations.

In accordance with a preferred embodiment of the present invention, the hologram is a reflection hologram or encompasses a reflection hologram. This feature has the advantage, among others, that the HOE can be used, for instance, on an eyeglass lens in a retinal scanner.

In accordance with a preferred embodiment, the holographic film is flat or is disposed, in particular applied, on a flat carrier substrate. Alternatively, the holographic film can be flexed or curved, in particular flexed in the same way as a surface of an eyeglass lens. What is advantageously achieved thereby is that the HOE produced by way of the method can be used on an eyeglass lens in a retinal scanner.

The HOE is produced in accordance with a method described above. It can be used in an aforementioned projection system. An HOE of this kind produced using the above-described method can be used, for instance, in a retinal scanner or in another wearable near-eye display.

The projection apparatus is provided for a set of data glasses. The projection apparatus has a light source for emitting a light beam, an HOE disposed or disposable on an eyeglass lens of the data glasses in order to project an image onto a retina of a user of the data glasses by deflecting the one light beam toward an ocular lens of the user and/or by focusing the one light beam, and a beam deflection element for reflecting the light beam onto the HOE.

The HOE is preferably a holographic optical element described above.

The eyeglass lens is provided for a set of data glasses, a holographic optical element being disposed on a surface of the eyeglass lens. The HOE is preferably disposed on that surface of the eyeglass lens which faces toward the user or toward an eye of the user.

The data glasses have at least one eyeglass lens as described above. The data glasses preferably have a projection apparatus described above.

The HOE, the eyeglass lens, and the data glasses have advantages that are the same as or similar to the method(s) described above.

### BRIEF DESCRIPTION OF THE DRAWINGS

Exemplifying embodiments of the present invention are depicted in the figures and are explained in further detail in the description below.

FIG. 1A shows a recording of a spherical wave deflector of the related art

FIG. 1B shows a reconstruction of a spherical wave deflector of the related art.

FIGS. 2A, 2B, and 2C show the deflection behavior of a spherical wave deflector for the case in which a Gaussian beam is incident onto the spherical wave deflector.

FIG. 3 is a schematic flow chart of a method in accordance with an exemplifying embodiment of the present invention.

FIG. 4 shows an assemblage for recording an HOE, in accordance with an exemplifying embodiment of the present invention.

FIG. 5 shows a reconstruction of the HOE whose production is illustrated in FIG. 4.

FIG. 6 shows an assemblage for recording an HOE, in accordance with a further embodiment of the present invention.

FIG. 7 shows a reconstruction of the HOE whose production is illustrated in FIG. 6.

FIG. 8 schematically depicts a projection apparatus in accordance with an example embodiment of the present invention.

FIG. 9 is a schematic isometric depiction of a set of data glasses in accordance with an example embodiment of the present invention.

### DETAILED DESCRIPTION OF EXAMPLE EMBODIMENTS

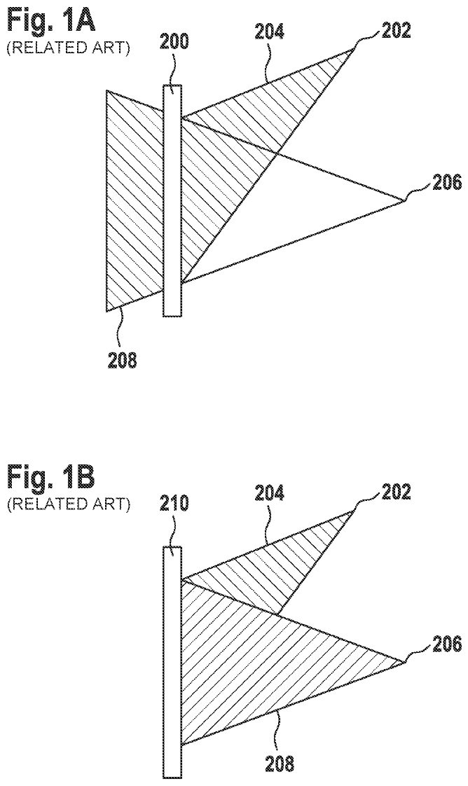

FIG. 1 shows in sub-FIG. 1A the recording, and in sub-FIG. 1B the reconstruction or playback, of an HOE, in particular a deflection HOE, in the present case a spherical wave deflector of the related art. Sub-FIG. 1A shows a holographic film 200 on which the light sources of two spherical waves are caused to interfere. First spherical wave 204 is divergent, is emitted from point 202, and is incident from the right (in the view of sub-FIG. 1A) onto holographic film 200. Second spherical wave 208 is convergent and is incident from the left (in the view of sub-FIG. 1A) onto holographic film 200 and, without holographic film 200, would be focused onto point 206. An interference pattern, from which HOE 210, in particular the deflection HOE or spherical wave deflector 211, is created is therefore recorded on holographic film 200.

Sub-FIG. 1B depicts the manner in which convergent spherical wave 208 is reconstructed with the aid of divergent spherical wave 204 which is now incident onto the completed HOE 210, in particular the deflection HOE.

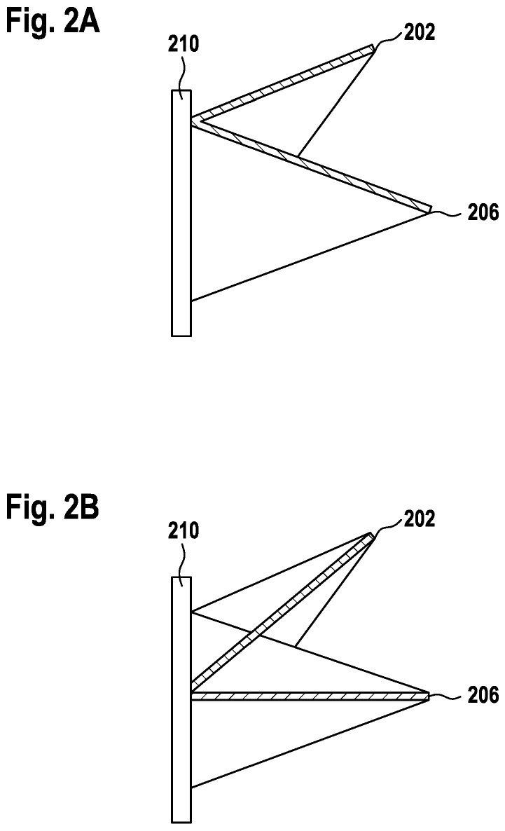

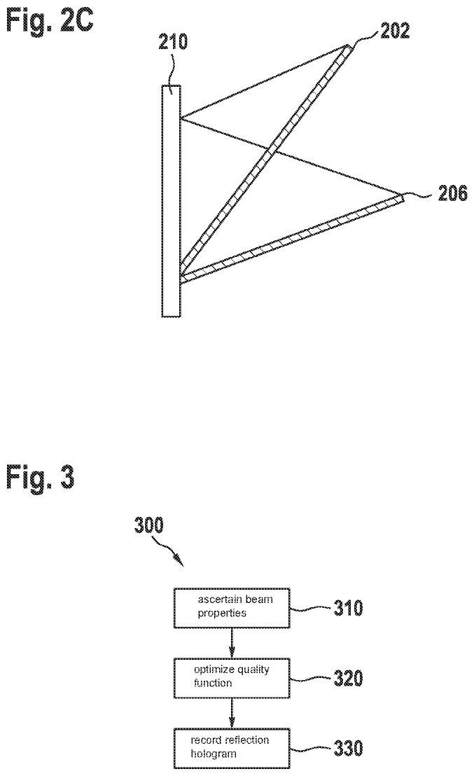

FIGS. 2A-2C show the manner in which spherical wave deflector 211 according to the related art serves locally as a deflection element for an incident Gaussian beam.

FIG. 2A shows the manner in which a Gaussian beam that, in the view of FIG. 2A (which is identical to the views of FIGS. 1A and 1B), is incident at the very top onto spherical wave deflector 211, becomes diffracted at point 206. FIG. 2B shows the manner in which a Gaussian beam that is incident onto spherical wave deflector 211 at the center becomes diffracted at point 206. FIG. 2C shows the manner in which a Gaussian beam that is incident at the very bottom onto spherical wave deflector 211 becomes diffracted at point 206. The diffraction at the holographic layer of spherical wave deflector 211 furthermore results in the overlaying of additional phase terms that, in some circumstances, result in a deviation of the propagation behavior from free-space propagation over a comparable distance. This can cause important beam parameters, for instance the radius and location of the beam waist, to be influenced by spherical wave deflection 211 in addition to free-space propagation, which can result in considerable deviations from the expected system properties.

FIG. 3 shows a method 300 for producing a holographic optical element (HOE) that is provided for projection in a projection system, in accordance with an example embodiment of the present invention.

In the first step 310, the beam properties that must be possessed by a projection beam which is used for the stipulated projection system are ascertained. In the present case, the beam property of rotational symmetry is optimized. A second Gaussian beam deflected by HOE 210, which is also called an “object beam,” is identical to the projection beam for the different configurations that are used.

In the next step 320, a quality function for the second Gaussian beam is optimized in order to adapt the second Gaussian beam to the projection system. The quality function is a weighted summing function that has, for the different configurations and for a respective predefined location between HOE 210 and a projection surface, a respective summand that is an indicator of the ellipticity of the respective beam. The necessary beam properties of the second Gaussian beam for the different configurations are obtained from the optimization.

In the next step 330, a reflection hologram is recorded by the fact that a first Gaussian beam and a second Gaussian beam are caused to interfere, for the different configurations, on a flat holographic film, the first Gaussian beam and the second Gaussian beam being radiated onto the film from different sides.

The first Gaussian beam is a reference beam that, for the different configurations, is identical to a reconstruction beam with which HOE 210 is reconstructed in the projection system.

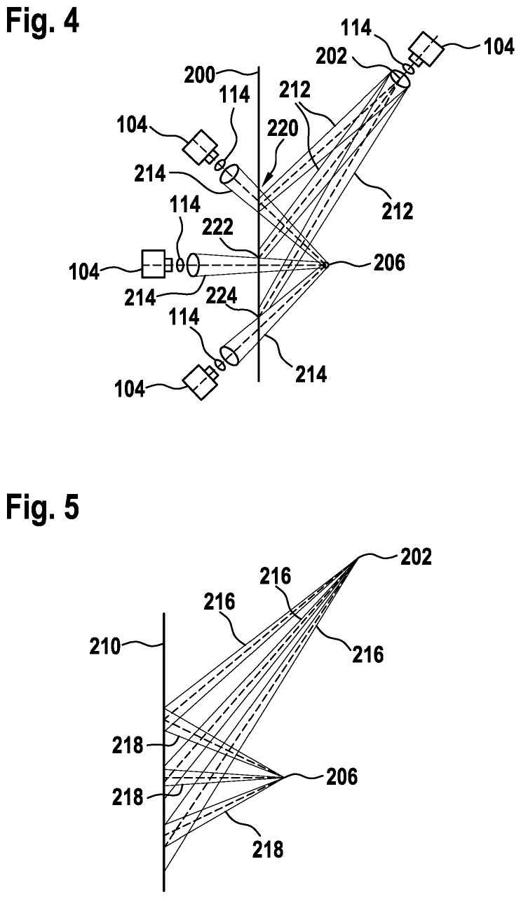

FIG. 4 shows the manner in which, for three different configurations, a first Gaussian beam 212 and a second Gaussian beam 214 are caused to interfere on holographic film 200 with the result that a hologram, HOE 210, in particular a deflection HOE, is recorded.

Both first Gaussian beam 212 and the second Gaussian beam are generated with the aid of a laser beam source 104 that is firstly collimated by way of a collimator 114 and then focused with the aid of a lens 115 of suitable focal length. Further optics, which are not depicted in the present case, may be necessary in order to correspondingly prepare the beam parameters of first Gaussian beam 212. With no limitation of generality, it can be assumed that one skilled in the art can experimentally modify and define the necessary beam parameters of first Gaussian beam 212 or of second Gaussian beam 214.

First Gaussian beam 212 is a reference beam that, for the three different configurations, is identical to a reconstruction beam 216 with which the HOE is reconstructed in the projection system. The reconstruction beam is shown in FIG. 5, which will be explained below. First Gaussian beam 212 can have different beam properties for the three different configurations.

Second Gaussian beam 214 is an object beam that, in the context of the reconstruction of HOE 210 utilizing reconstruction beam 216, is identical to a projection beam 218 that is used for projection in the projection system. Second Gaussian beam 214 can have different beam properties for the three different configurations.

For the three different configurations, the beam properties predefined for second Gaussian beam 214 or for projection beam 218 are the beam waist and the position thereof. These beam properties of projection beam 218 depend on the predefined projection properties of the projection system.

In the first configuration of first Gaussian beam 212 and of second Gaussian beam 214, first Gaussian beam 212 and second Gaussian beam 214 are incident onto holographic film 200 at a first location 220. In the second configuration of first Gaussian beam 212 and of second Gaussian beam 214, first Gaussian beam 212 and second Gaussian beam 214 are incident onto holographic film 200 at a second location 222. In the third configuration of first Gaussian beam 212 and of second Gaussian beam 214, first Gaussian beam 212 and second Gaussian beam 214 are incident onto holographic film 200 at a third location 224. Sub-holograms are thus recorded at first location 220, at second location 222, and at third location 224. After recording of the three sub-holograms, the completed HOE 210 exists.

FIG. 5 shows the manner in which HOE 210, whose recording was explained with reference to FIG. 4, is played back or reconstructed. First Gaussian beam 212 that was used in the context of the recording of HOE 210 is identical to reconstruction beam 216 that is illustrated in FIG. 5. If reconstruction beam 216 is incident onto HOE 210, it becomes deflected by HOE 210 into a projection beam 218 that is identical to second Gaussian beam 214 that was used to record HOE 210. This applies to all three configurations.

HOE 210 of FIG. 5 has the advantage, as compared with HOE 210 of FIG. 2A, 2B, or 2C, that projection beam 218 is rotationally symmetrical.

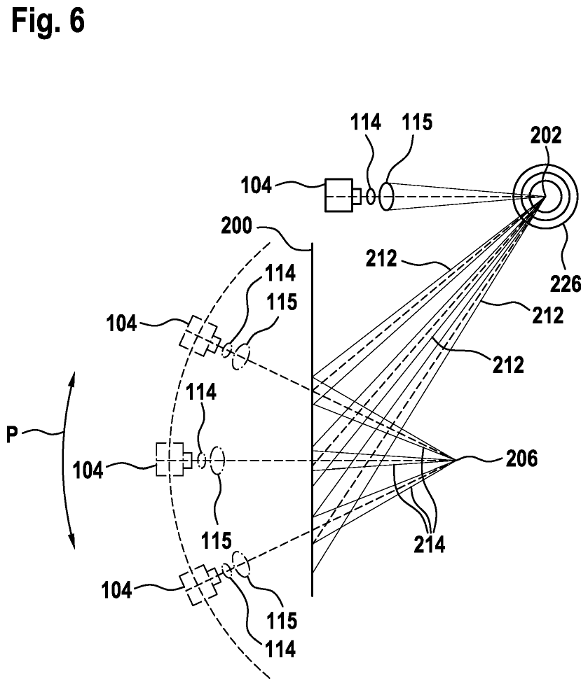

FIG. 6 corresponds substantially to FIG. 4. The three configurations of first Gaussian beam 212 differ, however, in that they have been generated by one and the same laser beam, by the fact that the laser beam that was emitted from laser beam source 104, collimated by collimator 114, and focused by lens 115 is deflected differently by a scannable beam deflection element 226. The three configurations of second Gaussian beam 214 are likewise generated by a single laser beam source 104, by the fact that laser beam source 104, along with collimator 114 and lens 115, is pivoted around point 206. This is indicated by arrow P in FIG. 6.

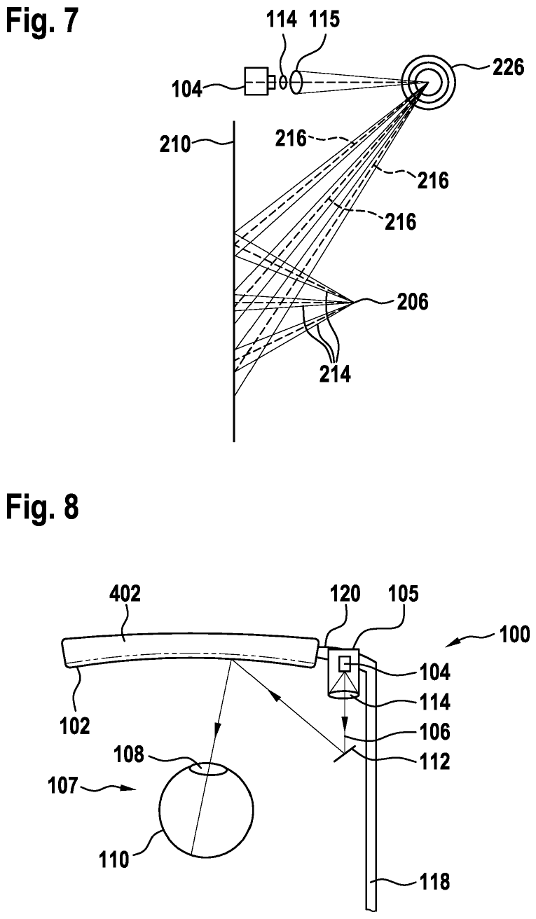

FIG. 7 shows a reconstruction or playback of the HOE 210 that was obtained by way of the method explained in FIG. 6.

FIG. 8 schematically shows the manner of operation of projection apparatus 100. A light beam 106 emitted from a laser diode constituting light source 104 is collimated by a lens constituting collimation element 114 and directed toward a micromirror constituting reflection element 112. Reflection element 112 deflects the light toward deflection element 102 embodied as an HOE. Deflection element 102 is applied onto an eyeglass lens 402. Light beam 106 deflected by deflection element 102 is then incident onto the eye and onto an ocular lens 108, from which light beam 106 becomes focused onto retina 110 of an eyeball 107 of a user.

Light source 104 is disposed in a housing 105 fastened on eyeglass frame 120. Collimation element 114 is disposed at the output of housing 105. Light source 104, collimation element 114, and reflection element 112 can be accommodated in a shared housing (not depicted), light beam 106 reflected from reflection element 112 being coupled out through a window disposed on one side of the housing. This housing can be fastened on eyeglass temple 118 or on eyeglass frame 120.

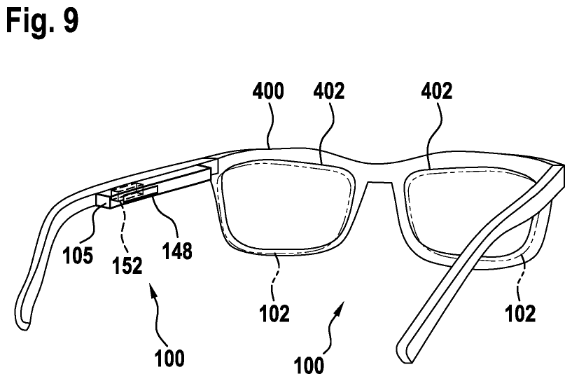

FIG. 9 schematically depicts a set of data glasses 400 having a projection apparatus 100 in accordance with an exemplifying embodiment. Projection apparatus 100 has a scanner optical system 152 and deflection element 102. Scanner optical system 152 is disposed in housing 105 and transmits a light beam 106 (not depicted) through exit window 148 onto deflection element 102. Data glasses 400 have an eyeglass lens 402 on which deflection element 102 is disposed. Deflection element 102 is implemented, for example, as part of eyeglass lens 402. Alternatively, deflection element 102 is implemented as a separate element and is connected to eyeglass 402 using a suitable joining method.

1-12. (canceled)

13. A method for producing a holographic optical element (HOE) that is provided for projection in a projection system, the method comprising:
recording a hologram by causing a first Gaussian beam and a second Gaussian beam to interfere on a holographic film for at least two different configurations, the first Gaussian beam being a reference beam that, for the at least two different configurations, is identical to a reconstruction beam with which the HOE is reconstructed, and the second Gaussian beam being an object beam that, upon reconstruction of the HOE utilizing the reconstruction beam, is identical to a projection beam that is used in the projection system for projection, and wherein, for the at least two different configurations, at least one beam property that depends respectively on predefined projection properties of the projection system is predefined for the second Gaussian beam.

14. The method as recited in claim 13, wherein the at least one beam property is a propagation direction, or a size of a beam waist, or a position of the beam waist.

15. The method as recited in claim 13, wherein a quality function for the second Gaussian beam is optimized.

16. The method as recited in claim 15, wherein the quality function is a weighted summing function that has, for the at least two different configurations and for a respective predefined location between the HOE and a projection surface, a respective summand that is a variable derived from the at least one beam property.

17. The method as recited in claim 13, wherein the hologram is a reflection hologram or encompasses a reflection hologram.

18. The method as recited in claim 13, wherein the holographic film is flat or curved.

19. A holographic optical element that includes a recorded hologram, the hologram being recorded by causing a first Gaussian beam and a second Gaussian beam to interfere on a holographic film for at least two different configurations, the first Gaussian beam being a reference beam that, for the at least two different configurations, is identical to a reconstruction beam with which the HOE is reconstructed, and the second Gaussian beam being an object beam that, upon reconstruction of the HOE utilizing the reconstruction beam, is identical to a projection beam that is used in the projection system for projection, and wherein, for the at least two different configurations, at least one beam property that depends respectively on predefined projection properties of the projection system is predefined for the second Gaussian beam.

20. A projection apparatus for a set of data glasses, the projection apparatus comprising:
a light source configured to emit a light beam;
a holographic optical element (HOE) disposed or disposable on an eyeglass lens of the data glasses to project an image onto a retina of a user of the data glasses by deflecting the light beam toward an ocular lens of the user and/or by focusing the light beam; and
a beam deflection element configured to reflect the light beam onto the HOE.

21. The projection apparatus as recited in claim 20, wherein the HOE is a holographic optical element that includes a recorded hologram, the hologram being recorded by causing a first Gaussian beam and a second Gaussian beam to interfere on a holographic film for at least two different configurations, the first Gaussian beam being a reference beam that, for the at least two different configurations, is identical to a reconstruction beam with which the HOE is reconstructed, and the second Gaussian beam being an object beam that, upon reconstruction of the HOE utilizing the reconstruction beam, is identical to a projection beam that is used in the projection system for projection, and wherein, for the at least two different configurations, at least one beam property that depends respectively on predefined projection properties of the projection system is predefined for the second Gaussian beam.

22. An eyeglass lens for a set of data glasses, wherein a holographic optical element (HOE) is disposed on a surface of the eyeglass lens, the HOE including a recorded hologram, the hologram being recorded by causing a first Gaussian beam and a second Gaussian beam to interfere on a holographic film for at least two different configurations, the first Gaussian beam being a reference beam that, for the at least two different configurations, is identical to a reconstruction beam with which the HOE is reconstructed, and the second Gaussian beam being an object beam that, upon reconstruction of the HOE utilizing the reconstruction beam, is identical to a projection beam that is used in the projection system for projection, and wherein, for the at least two different configurations, at least one beam property that depends respectively on predefined projection properties of the projection system is predefined for the second Gaussian beam.

23. A set of data glasses having at least one eyeglass lens, wherein a holographic optical element (HOE) is disposed on a surface of the eyeglass lens, the HOE including a recorded hologram, the hologram being recorded by causing a first Gaussian beam and a second Gaussian beam to interfere on a holographic film for at least two different configurations, the first Gaussian beam being a reference beam that, for the at least two different configurations, is identical to a reconstruction beam with which the HOE is reconstructed, and the second Gaussian beam being an object beam that, upon reconstruction of the HOE utilizing the reconstruction beam, is identical to a projection beam that is used in the projection system for projection, and wherein, for the at least two different configurations, at least one beam property that depends respectively on predefined projection properties of the projection system is predefined for the second Gaussian beam.

24. The set of data glasses as recited in claim 23, further comprising:
a projection apparatus including:
a light source configured to emit a light beam; and
a beam deflection element configured to reflect the light beam onto the HOE.
